(19) United States
(12) Patent Application Publication
(10) Pub. No.: US 2004/0193846 A1
(43) Pub. Date: Sep. 30, 2004

(54) Method and apparatus for utilizing multiple opportunity ports in a processor pipeline

(76) Inventor: Eric A. Sprangle, Portland, OR (US)

Correspondence Address: Dennis A. Nicholls, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/402,781

(22) Filed: Mar. 28, 2003

(51) Int. Cl. G06F 9/30

(52) U.S. Cl. 712/218

(57) ABSTRACT

A method and apparatus for a microprocessor with multiple memory read opportunity ports in a pipeline is disclosed. In one embodiment, a register file may have only one read port. When a statistically rare instruction requires two operands to be read from the register file, a spacer may be introduced into the pipeline, permitting the use of a second opportunity port to read its second operand from the register file at a later time. The spacer may be a nop, or it may be another instruction that receives its operands from a bypass path. In other embodiments, a register alias table may have only one read port, and a second opportunity port may be used to read a second physical register address.

### FIELD

The present disclosure relates generally to microprocessors, and more specifically to microprocessors utilizing a pipeline architecture.

### BACKGROUND

Modern microprocessors often use pipeline architectures. In a pipeline architecture, operations to be executed progress through various stages in a given order. Such stages may include prefetching, fetching, decoding, allocating, register renaming, queuing, scheduling, dispatching, reading registers, execution, and retirement. Placing such functional stages in a predetermined order may improve execution performance. The principle drawback of a pipelined architecture is the need to flush the pipeline and refill it upon reaching a branch that has been incorrectly predicted. However improvements in prediction logic have made this drawback less important than in the past. The use of pipelines has carried forward in the design of processors with parallel structure. In these, the pipeline may be widened to accommodate multiple simultaneous operations which can be executed by multiple execution units.

Certain of the stages in a pipeline involve reading to or writing from specialized memories. For example, in the register renaming stage, wherein logical register addresses are mapped to actual physical register addresses, a special memory called a register alias table (RAT) may be used. In the RAT, the logical address in a particular context may serve as the address of the RAT and the resulting physical register address may serve as the resulting data from the RAT. Similarly, in the register file read stage, a special memory called a register file may be used. In the register file, the physical register address is invoked to read from or write to the register file, and the resulting data may be used as an operand of an instruction. Other stages of a pipeline may involve the use of other forms of specialized memories.

The use of these specialized memories, which must be read from or written to from various stages, generally means that they must have multiple read and write ports. For example, if register files support instructions that require up to two operands, a worst-case design requires two simultaneous read ports for the register file. In the case of a pipelined processor that can process N instructions in parallel, the worst-case design would require 2N simultaneous read ports for the register file. Experience with the design of such specialized memories shows that the area required on the semiconductor die, as well as the power consumed, increases in proportion to square of the number of read plus write ports.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of portions of a pipeline of a baseline processor, according to one embodiment.

FIG. 2 is a schematic diagram of portions of a pipeline of a processor including two opportunity ports, according to one embodiment.

FIG. 3 is a schematic diagram of a bypass circuit for a register file, according to one embodiment of the present disclosure.

FIG. 4 is a schematic diagram of portions of a scheduler, according to one embodiment of the present disclosure.

FIG. 5A is a chart showing operations progressing in a pipeline, according to one embodiment of the present disclosure.

FIG. 5B is flowchart showing a method of scheduling operations in a pipeline, according to one embodiment of the present disclosure.

FIG. 6 is a schematic diagram of portions of a pipeline of a processor including three opportunity ports, according to one embodiment of the present disclosure.

FIG. 7 is schematic diagram of a bypass logic for a register alias file, according to one embodiment of the present disclosure.

FIG. 8 is a schematic diagram of a microprocessor system, according to one embodiment of the present disclosure.

### DETAILED DESCRIPTION

The following description describes techniques for a processor using pipelined architecture to reduce the number of simultaneous read and write ports in specialized memories, such as register alias tables or register files. In the following description, numerous specific details such as logic implementations, software module allocation, bus signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. The invention is disclosed in the form of a processor using pipelined architecture where the specialized memories are register alias files and register files. However, the invention may be practiced in other configurations of specialized memories used within processors.

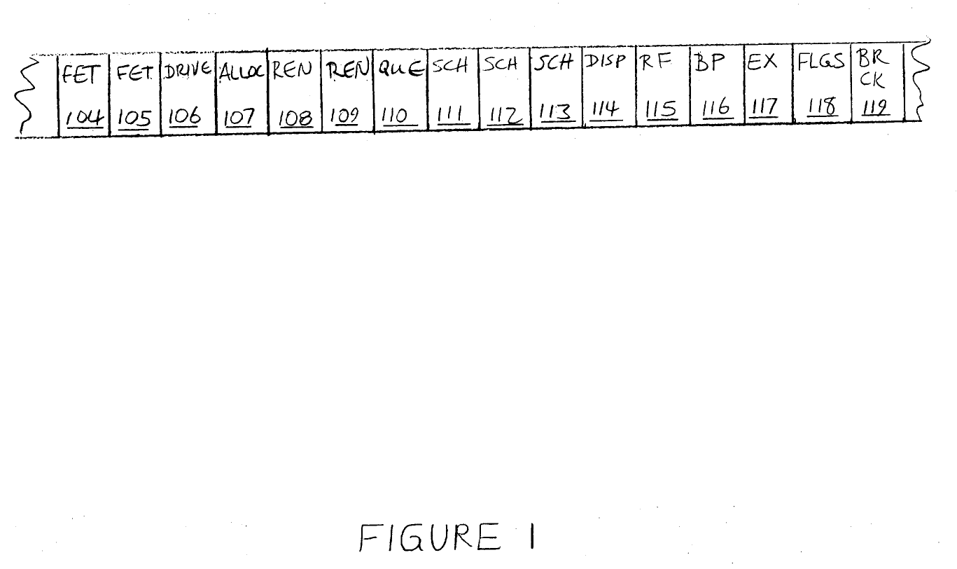

Referring now to FIG. 1, a schematic diagram of portions of a pipeline of a processor is shown, according to one embodiment. The pipeline of FIG. 1 is shown as an example, and in many other embodiments the stages shown may differ in function, quantity, and ordinal location within the pipeline. The specific stages of the shown pipeline may be used for a single-instruction at a time pipeline or in multiple-instruction at a time (parallel execution) pipeline. Some of the stages may occur over more than one time period, depending upon the timing in particular implementation details.

The fetch stages 104, 105 gather instructions from cache, which in some embodiments may be an instruction cache or a trace cache. Then the drive stage 106 accounts for the wire timing delays involved in supplying the micro-operations to the allocator. Once the allocator has these micro-operations, in the allocation stage 107 the subsequent resources of the processor may then be allocated to the various micro-operations.

In the register rename stages 108, 109 the logical registers used in the micro-operations are mapped to physical registers where the actual operand data will be found. In some embodiments this utilizes a register alias file (RAT). If micro-operations exist that require two operands, then in a worst-case situation there will be two reads from the RAT in the one set of register rename stages 108, 109. This would require the RAT to have 2 read ports. Note that it is statistically unlikely that the micro-operation requires two values held in the RAT. A micro-operation may require fewer than 2 read ports for many reasons. For example, the micro-operation may have only one register source (the other can be an immediate value). Furthermore, it is the nature of code that it is likely that the micro-operation directly follows the producer such that one or more of the source values are satisfied by the RAT bypass mux.

The queue stage 110 and schedule stages 111 , 112 perform the tasks of writing the micro-operations into the micro-operation queue and performing certain scheduling tasks, including the placement of micro-operations for out of order (OOO) execution. Then in the dispatch stage 114 the micro-operations are dispatched to the various execution units.

the register file read stage 115, the operands for the micro-operation may be read from the register file. In a similar manner as discussed in connection with the register rename stage 108, if micro-operations exist that require two operands, then in a worst-case situation there will be two reads from the register file in the register file read stage 115. This would require the register file to have 2 read ports. Note that it is statistically unlikely that the micro-operation requires two values held in the register file. A micro-operation may require fewer than 2 read ports for many reasons. For example, the micro-operation may have only one register source (the other can be an immediate value). Furthermore, it is the nature of out-of-order processors that it is likely that the micro-operation is dispatched such that one or more of the source values are satisfied by the bypass mux.

Subsequent to the register file read stage 115, there may be a bypass stage 166 to allow for time to recover those operands that may be supplied by a bypass path rather than by the register file itself. The actual execution occurs in the execution stage 117, after which various flags within the processor are set in the processor during the flags stage 118 and determination whether a branch occurs takes place in the branch check stage 119.

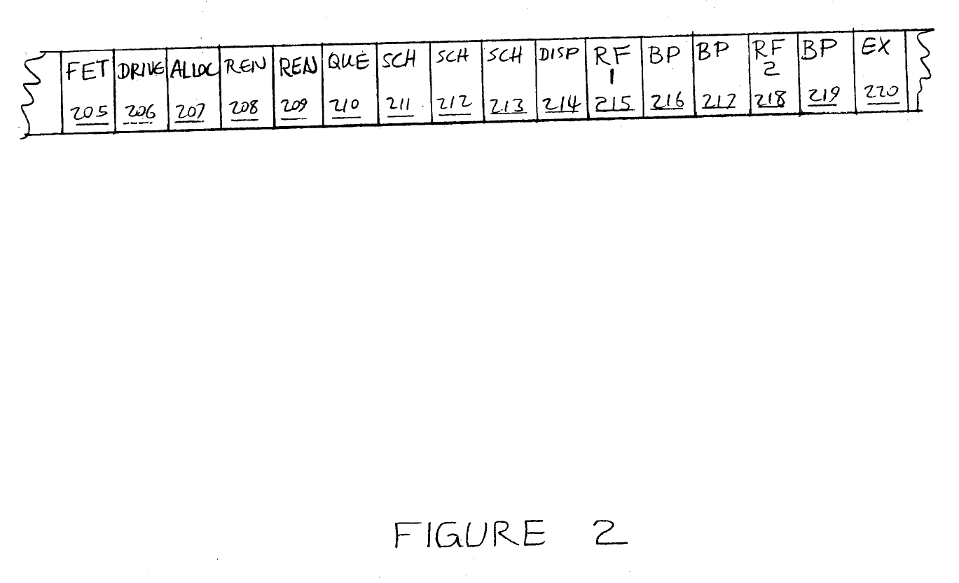

Referring now to FIG. 2, a schematic diagram of portions of a pipeline of a processor including two opportunity ports is shown, according to one embodiment. Many of the pipeline stages shown in FIG. 2 may have similar functions to those shown in FIG. 1. However, the FIG. 2 embodiment shows not one but two register file read stages 215, 218. Both of the register file read stages 215, 218 present opportunities for an operation to retrieve an operand from the register file. For this reason we may call these two register read file stages 215, 218 opportunity ports. In general, an opportunity port is a stage in a pipeline when a particular specialized memory, such as the RAT or the register file, may be read from or written to. However, the mere presence of an opportunity port does not mean that a given operation may read the memory without interfering with other operations reading the memory.

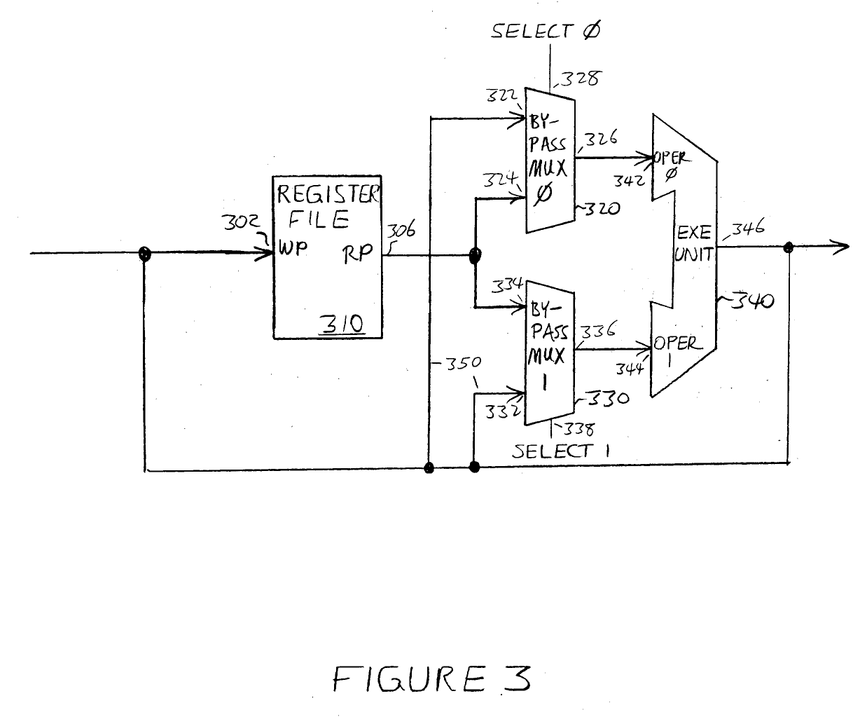

Referring now to FIG. 3, a schematic diagram of a bypass circuit for a register file is shown, according to one embodiment of the present disclosure. A register file 310 with two write ports 302, 304 but one read port 306 per execution unit 340 is shown, where only the data lines of the write ports 302, 304 and read port 306 are shown for clarity. In embodiments where there are multiple execution units (not shown), register file 310 may have one write port per execution unit. The register file 310 is configured to supply an operand to either operand port 0 342 or operand port 1 344 of an execution unit 340. However, in many cases operand port 0 342 or operand port 1 344 require operands that are the results of previous operations recently executed by execution unit 340. In order for these results of previous operations to arrive at the read port 306 of register file 310, they need to arrive at the write port 1 304 several clock cycles previously. This would permit first the writing of the data to the register file, and then the subsequent reading from the register file. In many circumstances there is not sufficient time for this to occur.

Therefore FIG. 3 shows a bypass path 350 that enables results of recent operation's execution to be fed back into the pipeline in a manner that bypasses the register file. The use of the bypass path 350 permits the use of operands that are the results from recently executed operations. In one embodiment, a pair of bypass multiplexers, bypass mux 0 320 and bypass mux 1 330, permits the selection of operands either from the register file 310 or from the bypass path 350. For example, let operand 0 of a current operation come from register file 310 and let operand 1 of that current operation be the result of the previous operation, available at the output 346 of the execution unit 340. Then bypass control circuitry may set the select 0 input 328 to select the register file input 324 of bypass mux 0 320 to appear at the output 326. This value then supplies the operand port 0 342 with the value retrieved from register file 310. However, operand 1 being the result of the previous operation may come through the bypass path 350 into select 1 input 332 of bypass mux 1 330. Then bypass control circuitry may set the select 1 input 338 to select the bypass path input 332 of bypass mux 1 330 to appear at the output 336. This value then supplies the operand port 1 344 with the value retrieved from the bypass path 350.

In this manner, even though register file 310 only has one read port 306, execution unit 340 may receive its operands in the cases when no or only one operand are required, or when one operand is read from register file 310 and one operand is provided by the bypass path 350. Only in those cases where two operands are to be read from register file 310 may another read from register file 310 in a second opportunity port of the pipeline be needed. This may require ensuring that another operation may not attempt to use the register file read port 306 when the pending operation attempts to use it.

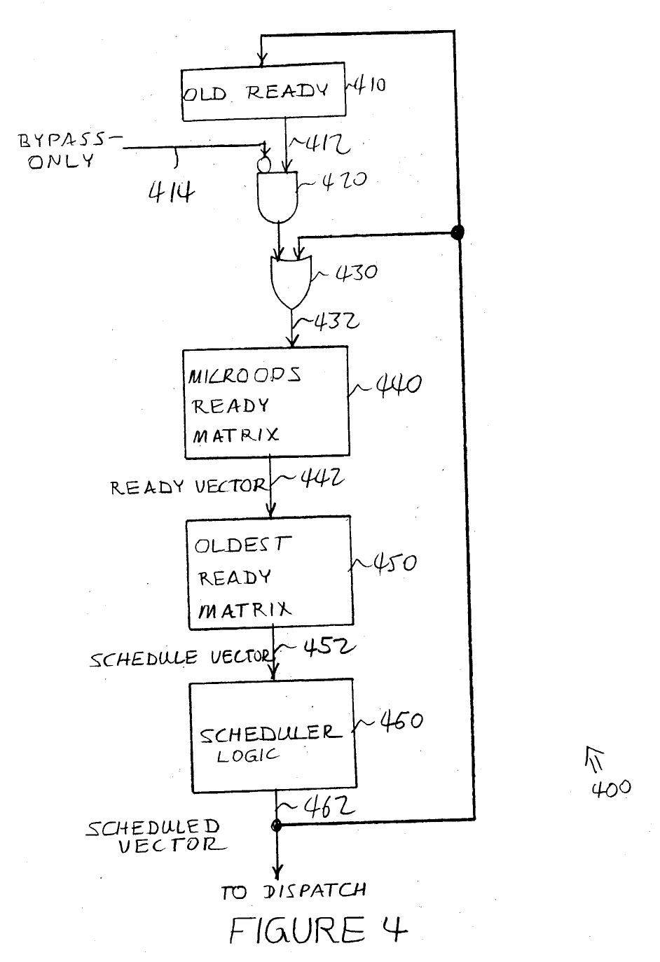

Referring now to FIG. 4, a schematic diagram of portions of a scheduler 400 is shown, according to one embodiment of the present disclosure. In one embodiment, a group of pending micro-operations is represented by a micro-operations ready matrix 440. Various sizes of micro-operations ready matrix 440 are possible, but in one embodiment 12 pending micro-operations are supported. The output of micro-operations ready matrix 440 is ready vector 442, using “1-hot encoding”. In other words, each bit of the ready vector 442 is a true/false flag giving the ready status of the micro-operations. In one embodiment, being “ready” may mean that all of the required operands will be available in the register file 310, if the micro-operation were chosen for scheduling, and that none of the operands may need be taken from a bypass path 350. The ready vector 442 signals to the oldest ready matrix 450 which of the 12 pending micro-operations are ready. Then the oldest ready matrix 450 may present a schedule vector 452 which selects the oldest micro-operation which is ready. Using the schedule vector 452, a scheduler logic 460 may then actually send the selected micro-operation on to the next pipeline stage, and issue a scheduled vector 462 when it does.

The scheduled vector 462 may be used as feedback to the micro-operations ready matrix 440, telling it which micro-operations have been send down the pipeline. The present scheduled vector 462 may be gated at gate 430 with a saved version of a previous scheduled vector, stored in the old ready 410. These scheduled vectors may in combination be used for housekeeping in the micro-operations ready matrix 440.

When an micro-operation wishes to use the second opportunity port, it may indicate that it wishes to have scheduled a “single register file source” micro-operation, in other words a micro-operation which will need to get an operand from bypass. When this situation occurs, a bypass-only signal line 414 may negate the feedback as disclosed above. This will cause only “single register file source” micro-operations to be scheduled next, if possible.

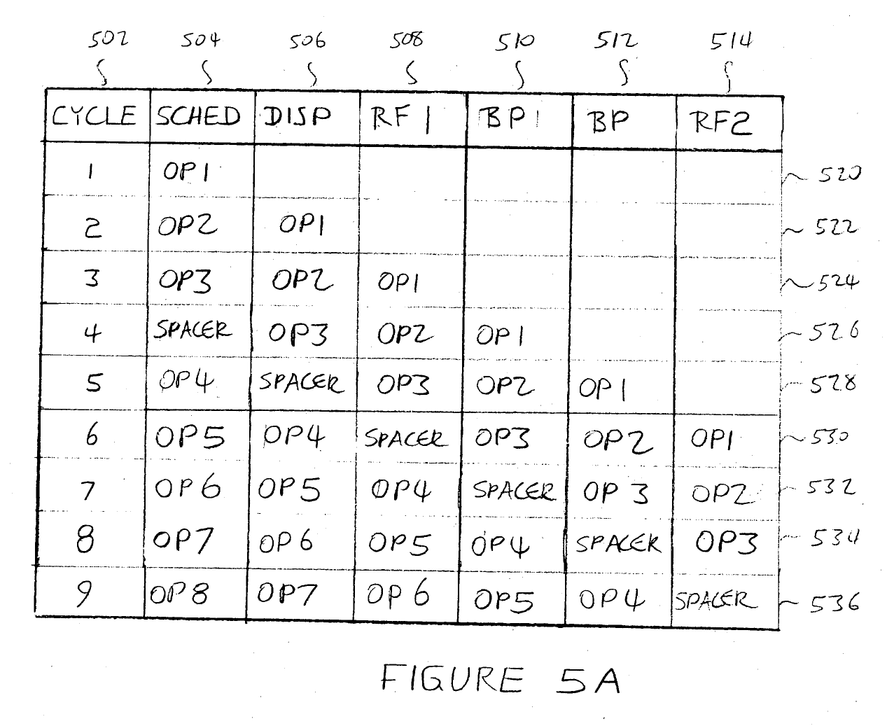

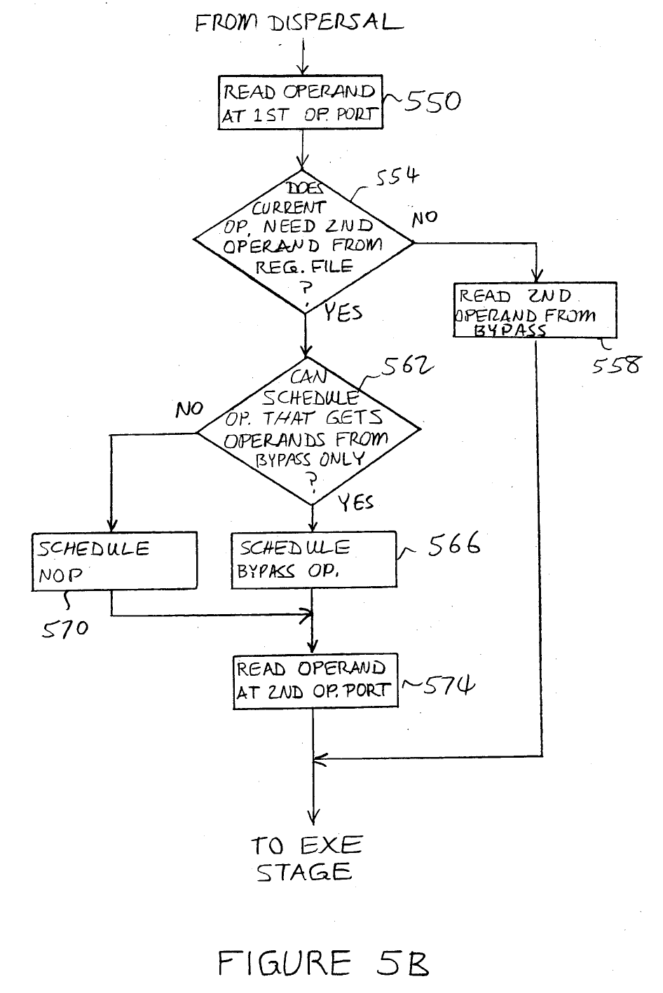

Referring now to FIG. 5A, a chart showing operations progressing in a pipeline is shown, according to one embodiment of the present disclosure. FIG. 5A shows micro-operations moving through representative pipeline stages, such as schedule stage 504, dispatch stage 506, register file read 1 stage 508, bypass stages 510, 512, and register file read 2 stage 514, in increasing time measured by the cycles in column 502. For example, op 1 is in schedule stage 504 during cycle 1, at register file read 1 stage 508 during cycle 3, and at register file read 2 stage 514 during cycle 6. Register file read 1 stage 508 and register file read 2 stage 514 are two examples of opportunity ports.

For the FIG. 5A example, let op1 require two operands be read from the register file, not from a bypass path. It may not be possible to determine whether a given micro-operation will require two operands be read from the register file until the micro-operation is at a pipeline stage one or more cycles after the scheduler stage 504. Presume in this case that in regards op1 it is determined that both operands need to be read from the register file only after op1 reaches the register file read 1 stage 508 during cycle 3. Recall that in one embodiment the FIG. 3 register file 310 only has one read port per execution unit. Therefore op 1 may only obtain one of its operands from the register file read 1 stage 508 and must obtain the other operand during the register file read 2 stage 514 during cycle 6. In order to ensure that op 1 may use register file read port in stage 514, during cycle 4 the schedule stage 504 inserts a spacer into the instruction flow. This spacer may be a micro-operation requiring at most one operand to be read from the register file, which may be selected as discussed in connection with FIG. 4 above. If such a micro-operation is not available, then the spacer may be a no-operation (nop).

In order that the spacers may arrive at the register file read 1 stage 508 at an appropriate time, the number of cycles between the register file read 1 stage 508 and register file read 2 stage 514 should be carefully chosen. In general it may be seen from FIG. 5A that if there is N pipeline stages between the schedule stage 504 and the register file read 1 stage 508, there should be N+1 pipeline stages between the register file read 1 stage 508 and the register file read 2 stage 514.

Referring now to FIG. 5B, a flowchart shows a method of scheduling operations in a pipeline, according to one embodiment of the present disclosure. The FIG. 5B process generally follows the example shown in FIG. 5A, but shows more alternative options. Micro-operations are released from dispatch and arrive in the register file read 1 stage. Then in block 550 the first operand of the micro-operation may be read from the register file using a first opportunity port, if necessary.

Then in decision block 554, it is determined whether the current micro-operation needs to retrieve a second operand from the register file. If the answer is no, then the process exits along the NO branch, and proceeds to block 558. There the second operand may be retrieved from the bypass path, if necessary. The process then exits to the execution stage. If, however, the answer is yes, then the process exits along the YES branch, and proceeds to decision block 562.

In decision block 562, it is determined whether it is possible to schedule a succeeding micro-operation that gets its operands, if necessary, from the bypass path. In other embodiments, it may be determined whether it is possible to instead schedule a succeeding micro-operation that only gets one operand from the register file. If the answer is yes, then the process exits along the YES branch, and in block 566 that “bypass” micro-operation is scheduled. If, however, the answer is no, then the process exits along the NO branch, and in block 570 a nop is scheduled. In either case, in block 566 or in block 570 a spacer of one form or another is scheduled so that the pending micro-operation may then in block 574 read its second operand from the register file in a second opportunity port.

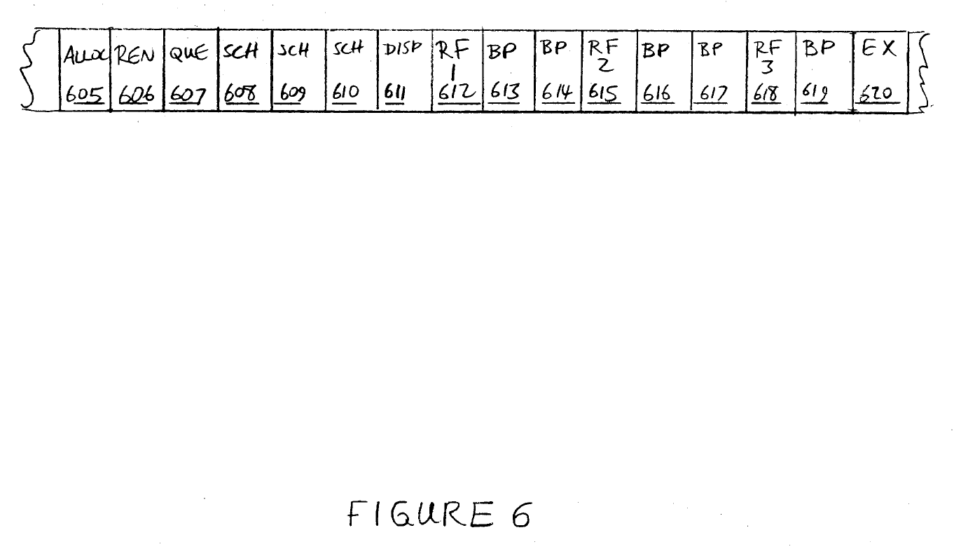

Referring now to FIG. 6, a schematic diagram of portions of a pipeline of a processor including three opportunity ports, according to one embodiment of the present disclosure. Many current instruction sets limit the number of operands to two. Expanding such an instruction set to include even a few instructions requiring three operands would generally require register files to include three read ports (per instruction unit). As mentioned previously, the die size and power consumption would increase greatly if three read ports were used on a register file.

Therefore, in the FIG. 6 embodiment, the pipeline includes three opportunity ports for reading from the register file: register file read opportunity 1 stage 612, register file read opportunity 2 stage 615, and register file read opportunity 3 stage 618. These three opportunity ports present the opportunity for the statistically rare but possible event of one of the instructions having three operands to read all three from the register file. In such a case, the schedule stages 608, 609, 610 could supply two spacers, such as a nop or an instruction requiring operands which could be obtained via a bypass path. A person skilled in the art would readily be able to extend the techniques disclosed in connection with FIGS. 2 through 5B above for use with the FIG. 6 pipeline.

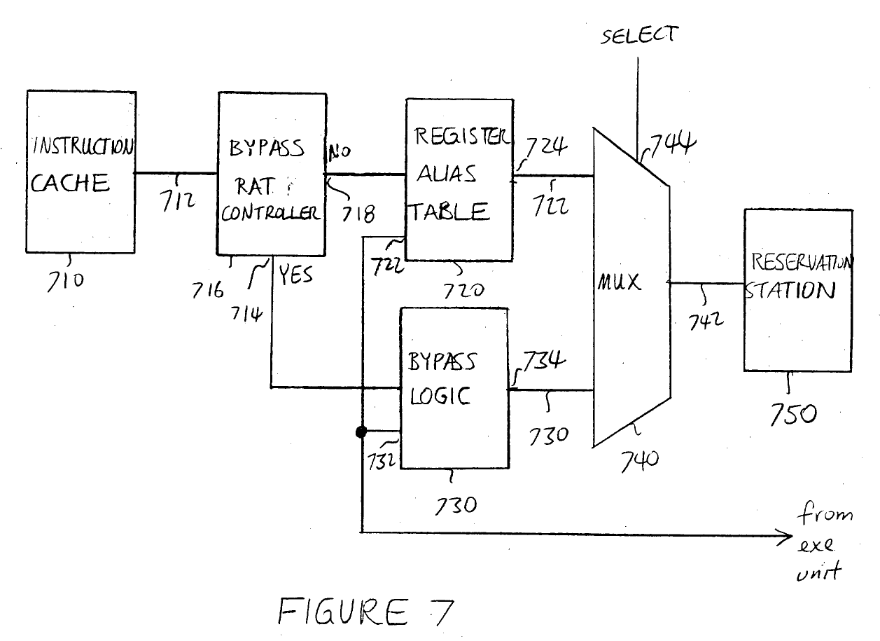

Referring now to FIG. 7, a schematic diagram of a bypass logic 730 for a register alias table (RAT) 720 is shown, according to one embodiment of the present disclosure. A RAT 720 is a particular form of a memory that may be used to translate logical register addresses, such as used in instructions, to physical register addresses, such as used in a register file. The translation of logical register addresses to physical register addresses permits the use of many times more actual registers than would appear supported by a particular instruction set.

To support instructions that require two operands, previous embodiments of a RAT required two read ports. But in the FIG. 7 embodiment, a single read port 724 of RAT 720 may be used. As in the case of the register files discussed previously, the contents of RAT 720 may be modified depending upon the results of instruction execution in an execution unit. This may be carried out by the data path from the execution unit entering a write port 722 on RAT 720. But there also may be a bypass path 732 for changes in the translation from logical register address to physical register address brought about by recently executed instructions. The bypass path may feed a bypass logic 730. The use of the bypass logic 730 may be controlled by a bypass RAT controller 716. The bypass RAT controller 716 may evaluate whether an instruction in an instruction cache 710 may get zero, one, or two of the physical register addresses for its operands from the RAT 720, or alternately if some of the physical register addresses may come via the bypass logic 730.

To work with the FIG. 7 circuits, additional opportunity ports may be placed into the processor's pipeline. For example, in the FIG. 1 embodiment, there may be an additional REN stage located subsequent to the existing REN stages 108, 109. Then when a micro-operation is at a first REN stage, the bypass RAT controller may determine whether the micro-operation may get zero, one, or two physical register addresses from the RAT 720. If less than two, then the bypass RAT controller 716 may use its NO output 718 and send the logical address to the RAT 720. If a second logical address is needed from the bypass logic 730, then the bypass RAT controller 716 may use its YES output 714 and send the logical address to the bypass logic 730. The bypass RAT controller may select the resulting physical addresses from the read port 724 of RAT 720 and the read port 734 of bypass logic 730 using the select line 744 of mux 740. The output of mux 740 may be temporarily stored in a reservation station 750.

In the event that the micro-operation will need two physical addresses from the RAT 720, the bypass RAT controller 716 may perform a localized stall, which may viewed as the adding of a spacer to the instruction flow. In one embodiment, the spacer may be a nop or the logical equivalent of a nop. The spacer permits the pending micro-operation to read a second time from the RAT 720 during a second opportunity port (second REN stage).

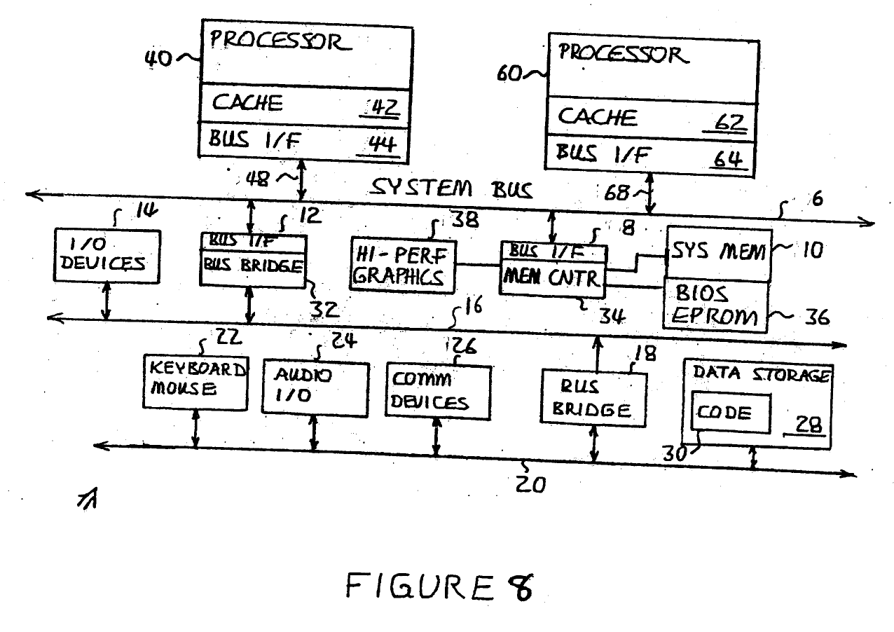

Referring now to FIG. 8, a schematic diagram of a microprocessor system is shown, according to one embodiment of the present disclosure. The FIG. 8 system may include several processors of which only two, processors 40, 60 are shown for clarity. Processors 40, 60 may include level one caches 42, 62. The FIG. 8 multiprocessor system may have several functions connected via bus interfaces 44, 64, 12, 8 with a system bus 6. In one embodiment, system bus 6 may be the front side bus (FSB) utilized with Pentium® class microprocessors manufactured by Intel® Corporation. A general name for a function connected via a bus interface with a system bus is an “agent”. Examples of agents are processors 40, 60, bus bridge 32, and memory controller 34. In some embodiments memory controller 34 and bus bridge 32 may collectively be referred to as a chipset. In some embodiments, functions of a chipset may be divided among physical chips differently than as shown in the FIG. 8 embodiment.

Memory controller 34 may permit processors 40, 60 to read and write from system memory 10 and from a basic input/output system (BIOS) erasable programmable read-only memory (EPROM) 36. In some embodiments,BIOS EPROM 36 may utilize flash memory. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface, or an AGP interface operating at multiple speeds such as 4× AGP or 8× AGP. Memory controller 34 may direct read data from system memory 10 to the high-performance graphics circuit 38 across high-performance graphics interface 39.

Bus bridge 32 may permit data exchanges between system bus 6 and bus 16, which may in some embodiments be a industry standard architecture (ISA) bus or a peripheral component interconnect (PCI) bus. There may be various input/output I/O devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An apparatus, comprising:
a memory with a write port and a read port;
a pipeline with a first opportunity port and a second opportunity port; and
a bypass path.

2. The apparatus of claim 1, wherein said memory is a register file.

3. The apparatus of claim 2, wherein a first instruction at said first opportunity port may use said second opportunity port by inserting a spacer operation into said pipeline.

4. The apparatus of claim 3, wherein said spacer operation is a nop.

5. The apparatus of claim 3, wherein said spacer operation is a second operation whose operands will be supplied by said bypass path.

6. The apparatus of claim 5, further comprising a bypass-only signal path to enable operations whose operands will be supplied by said bypass path to pass from a ready matrix to a scheduler.

7. The apparatus of claim 3, wherein said second opportunity port is N+1 pipeline stages after said first opportunity port when said first opportunity port is N pipeline stages after a scheduler stage.

8. The apparatus of claim 1, wherein said memory is a register alias file.

9. The apparatus of claim 8, wherein a first instruction at said first opportunity port may use said second opportunity port to read a physical register address from said register alias file by inserting a spacer operation into said pipeline.

10. The apparatus of claim 9, wherein said spacer operation is a nop.

11. The apparatus of claim 9, further comprising decision logic located prior to said write port of said register alias file to determine whether to transform a logical register address to said physical register address by using said register alias file or by using said bypass path.

12. The apparatus of claim 11, wherein said bypass path includes a bypass logic.

13. A method for reading from a memory, comprising:
reading a first data from said memory at a first opportunity port;
determining whether a second data should be read from said memory or from a bypass path;
if said second data should be read from said memory, scheduling a spacer to permit reading at a second opportunity port; and
reading said second data from said memory at said second opportunity port.

14. The method of claim 13, wherein said reading a first data includes reading from a register file.

15. The method of claim 14, wherein said scheduling a spacer includes determining whether an operation which obtains its operands from said bypass path is available for scheduling.

16. The method of claim 15, wherein if said determining does find that an operation which obtains its operands from said bypass path is available for scheduling, then scheduling said operation.

17. The method of claim 15, wherein if said determining does not find that an operation which obtains its operands from said bypass path is available for scheduling, then scheduling a nop.

18. The method of claim 13, wherein said reading a first data includes reading from a register alias file.

19. The method of claim 18, wherein said scheduling a spacer includes scheduling a nop.

20. An apparatus, comprising:
means for reading a first data from a memory at a first opportunity port;
means for determining whether a second data should be read from said memory or from a bypass path;
means for, if said second data should be read from said memory, scheduling a spacer to permit reading at a second opportunity port; and
means for reading said second data from said memory at said second opportunity port.

21. The apparatus of claim 20, wherein said means for reading a first data includes means for reading from a register file.

22. The apparatus of claim 21, wherein said means for scheduling a spacer includes means for determining whether an operation which obtains its operands from said bypass path is available for scheduling.

23. The apparatus of claim 22, wherein if said means for determining does find that an operation which obtains its operands from said bypass path is available for scheduling, then scheduling said operation.

24. The apparatus of claim 22, wherein if said means for determining does not find that an operation which obtains its operands from said bypass path is available for scheduling, then scheduling a nop.

25. The apparatus of claim 20, wherein said means for reading a first data includes means for reading from a register alias file.

26. The apparatus of claim 25, wherein said means for scheduling a spacer includes scheduling a nop.

27. A system, comprising:
a processor including a memory with a write port and a read port, a pipeline with a first opportunity port and a second opportunity port, and a bypass path;
a first bus coupled to said processor;
a memory controller coupled to said first bus and to a graphics interface;
a second bus coupled to said first bus; and
an audio input/output interface coupled to said second bus.

28. The system of claim 27, wherein said memory is a register file.

29. The system of claim 28, wherein a first instruction at said first opportunity port may use said second opportunity port by inserting a spacer operation into said pipeline.

30. The system of claim 29, wherein said spacer operation is a nop.

31. The system of claim 29, wherein said spacer operation is a second operation whose operands will be supplied by said bypass path.

32. The system of claim 31, further comprising a bypass-only signal path to enable operations whose operands will be supplied by said bypass path to pass from a ready matrix to a scheduler.

33. The system of claim 29, wherein said second opportunity port is N+1 pipeline stages after said first opportunity port when said first opportunity port is N pipeline stages after a scheduler stage.

34. The system of claim 27, wherein said memory is a register alias file.

35. The system of claim 34, wherein a first instruction at said first opportunity port may use said second opportunity port to read a physical register address from said register alias file by inserting a spacer operation into said pipeline.

36. The system of claim 35, wherein said spacer operation is a nop.

37. The system of claim 36, further comprising decision logic located prior to said write port of said register alias file to determine whether to transform a logical register address to said physical register address by using said register alias file or by using said bypass path.

38. The system of claim 37, wherein said bypass path includes a bypass logic.
